(19) United States
(12) Patent Application Publication
(10) Pub. No.: US 2017/0207692 A1
(43) Pub. Date: Jul. 20, 2017

(54) MAGNETIC CLUTCH FOR COUPLING ARRANGEMENT

(71) Applicant: SIEMENS AKTIENGESELLSCHAFT, München (DE)

(72) Inventors: Georg Bachmaier, München (DE); Christian Bachmann, München (DE); Matthias Gerlich, München (DE); Andreas Gödecke, München (DE); Iason Vittorias, München (DE)

(21) Appl. No.: 15/301,039

(22) PCT Filed: Mar. 31, 2015
(86) PCT No.: PCT/EP2015/057085

§ 371 Date: Oct. 26, 2016

(30) Foreign Application Priority Data
Apr. 2, 2014 (DE) 10 2014 206 284.5

(51) Int. Cl. H02K 49/06

(52) U.S. Cl. CPC H02K 49/06

(57) ABSTRACT

Embodiments relate to a magnetic coupling, comprising a first coupling part, that can be rotated about an axis of rotation, a second coupling part, that can be rotated about the axis of rotation, and at least one coil, that is configured to generate a magnetic field along the axis of rotation through the first and second coupling parts for contactless transmission of a torque between the first and second coupling parts. A magnetic coupling having a magnetic field along the axis of rotation reduces forces that act on the coupling parts in a radial direction.

### CROSS-REFERENCE TO RELATED APPLICATIONS

The present patent document is a §371 nationalization of PCT Application Ser. No. PCT/EP2015/057085, filed Mar. 31, 2015, designating the United States, which is hereby incorporated by reference, and this patent document also claims the benefit of DE 10 2014 206 284.5, filed on Apr. 2, 2014, which is also hereby incorporated by reference.

### TECHNICAL FIELD

Embodiments relate to a magnetic coupling. Embodiments further relate to a coupling arrangement. Embodiments also relate to a method for controlling a magnetic coupling.

### BACKGROUND

A torque may be transmitted from one shaft to another shaft in a contactless manner with the aid of magnetic couplings. There are numerous solutions for magnetic couplings. The solutions are often based on magnetic fields that are generated by permanent magnets. A simple magnetic coupling includes two rotating magnets that are arranged one in the other. The magnetic coupling provides a coupling that is contactless, but cannot be separated. If one side of the coupling is replaced by a rotating field winding, the coupling may also be switchable.

DE 10 2012 206 345 A1 discloses a magnetic coupling for coupling a first shaft to a second shaft. The magnetic coupling uses a magnetic field that runs radially in relation to the rotation axis, in order to transmit a torque from the first shaft to the second shaft.

### SUMMARY AND DESCRIPTION

The scope of the present invention is defined solely by the appended claims and is not affected to any degree by the statements within this summary. The present embodiments may obviate one or more of the drawbacks or limitations in the related art.

It is an object of the present embodiments to provide an improved magnetic coupling, an improved coupling arrangement and also an improved method.

Accordingly, a magnetic coupling is provided that includes a first coupling part that may be rotated about a rotation axis, a second coupling part that may be rotated about the rotation axis, and at least one coil. The coil is configured to generate a magnetic field along the rotation axis through the first and second coupling parts for contactless transmission of a torque between the first and second coupling parts.

The torque is transmitted from the first coupling part to the second coupling part and/or in the reverse direction. The first coupling part and/or the second coupling part may be, for example, part of a shaft. The first coupling part and/or the second coupling part may also be connected to a shaft. The first and second coupling part may also be magnetisable. The first coupling part and/or the second coupling part may, for example, be made from a material that has a magnetic permeability of >1 or, for example >80.

The term “axial” is intended to be understood as referring to a direction along the rotation axis, and “radial” is intended to be understood as referring to a direction perpendicular to the rotation axis.

The term contactless transmission refers to transmission without touching, e.g. the first coupling part and the second coupling part are not in contact with one another. The first coupling part and the second coupling part may be separated from one another by an axial air gap. The contactless transmission of the torque between the first coupling part and the second coupling part may also be transmitted through a material, for example, through a non-magnetisable material.

Contactless transmission of the torque between the first coupling part and the second coupling part allows for mechanical friction losses to be reduced. As a result, the torque may be transmitted more efficiently. Mechanical wear on the torque transmitting coupling parts may also be avoided or reduced. Less mechanical wear leads to less wear of the torque-transmitting coupling parts. As a result, a coupling of which the torque-transmitting coupling parts require less servicing may be provided.

The at least one coil or a respective coil, referred to as coil, may have N windings of an electrical conductor that is configured to carry an electric current. The at least one coil or a respective coil, referred to as coil, may be configured, for example, to generate an axial and/or radial magnetic field.

The at least one coil may generate a magnetic field of which the field lines run along the rotation axis from the first coupling part to the second coupling part, and vice versa. The magnetic field may be generated, for example, by a cylindrical coil of which the longitudinal axis is parallel to the rotation axis. Alternatively, the coil may be formed by a coil pair, such as a coil pair in Helmholtz configuration for example.

The strength of the magnetic field that is generated by the coil is proportional to the electric current that flows through the coil. The strength of the magnetic field that is generated by the coil may be controlled by the electric current.

Magnetic couplings may have, for example, a negative stiffness along the magnetic field axis. The term “negative stiffness” is understood to mean that a force that couples two bodies to one another, for example in an attractive manner, is greater the closer the two bodies come in relation to one another. Therefore, a negative stiffness does not permit a stable state as a force which brings the two bodies closer together is greater the closer the two bodies are. A bearing may be used to compensate for a negative stiffness.

A magnetic coupling with a magnetic field along the rotation axis, e.g. an axial magnetic field, may have a negative stiffness of the magnetic coupling that occurs only along the rotation axis. A force that acts on the coupling parts on account of the negative stiffness of the magnetic coupling occurs only along one axis, the rotation axis. Forces that act on the coupling parts in the radial directions may be reduced. The forces that have to be absorbed by radial bearings may be reduced.

For a magnetic coupling with a magnetic field that is generated by a coil, the transmission of a torque between the first coupling part and the second coupling part may be interrupted by simply switching off the current flow through the coil. The transmitted torque of the coupling may be regulated by the current flow or the transmitted torque may be realized as a function of an amount of current. Therefore, any desired torque values up to a maximum torque that the coupling is configured for may be set by a suitable control.

The magnetic coupling may be used in a mechanical energy store or may form part of an energy store. The mechanical energy store may be used, for example, in an emergency power generator. The energy store may supply mechanical energy to a generator in the event of a malfunction in the power supply system. The generator may convert the mechanical energy into electrical energy in order to provide emergency power. The energy store may be configured to provide the energy only over a short period of time, until an emergency diesel power generator starts up. For example, the mechanical energy store may provide 100 kW for up to 15 seconds.

The magnetic coupling may be used in hybrid vehicles, for example hybrid buses or hybrid motor vehicles.

According to an embodiment, the magnetic coupling further includes a first auxiliary coil that is configured to generate a magnetic field along the rotation axis. The first auxiliary coil is arranged along the rotation axis at a distance from the at least one coil.

A magnetic bearing may be provided in the axial direction by a suitable control of the first auxiliary coil and the at least one coil. An additional bearing in the axial direction, for example, an additional magnetic bearing, may be dispensed with.

Magnetic stray fields may also occur in the magnetic coupling, for example in the radial direction. The magnetic stray fields may cause, for example, weakening of a magnetic flux density in the axial direction. The weakening of the magnetic flux density may result in the two coupling parts moving toward one another or away from one another. The first auxiliary coil may be configured, for example, to change a magnetic flux density of the magnetic field in such a way that undesired stray fields are countered. For example, the magnetic field that is generated by the first auxiliary coil may prevent the first coupling part and the second coupling part from moving toward one another or away from one another.

The first auxiliary coil may also have a lower inductance than the at least one coil. A time constant of a current increase in a coil is proportional to the inductance of the coil. Since a strength of a magnetic field that is generated by the coil is proportional to the current flowing through the coil, a magnetic field of a coil with a lower inductance may be changed more quickly. The coil may react more quickly to a change in a distance between the two coupling parts.

In an embodiment, the magnetic coupling further includes a second auxiliary coil that is configured to generate a magnetic field along the rotation axis. The second auxiliary coil is arranged on that side of the coil that is situated opposite the first auxiliary coil and along the rotation axis at a distance from the coil.

The second auxiliary coil may be physically identical to the first auxiliary coil. The second auxiliary coil may have a lower inductance than the coil. The second auxiliary coil may have the same inductance as the first auxiliary coil. For the second auxiliary coil, stray fields that occur may be compensated for even more effectively. For example, undesired influences on the first coupling part and on the second coupling part owing to stray fields may be compensated for exclusively using the first and second auxiliary coils. As a result, excitation of the at least one coil, e.g. an electric current flow through the coil, may be kept constant. Excitation may be kept constant so that the magnetic field that is generated by the coil may be changed only relatively slowly.

In an embodiment, the magnetic coupling further includes at least three radial auxiliary coils that are configured to generate a magnetic field radially in relation to the rotation axis. The at least three radial auxiliary coils are arranged distributed circumferentially with respect to the rotation axis around the first coupling part and/or the second coupling part.

The at least three radial auxiliary coils may be arranged in a manner distributed equidistantly from one another with respect to the rotation axis. For example, forces that act on the first coupling part and/or the second coupling part radially in relation to the rotation axis may be compensated for by the at least three radial auxiliary coils.

A magnetic coupling that has both at least one auxiliary coil, that generates a magnetic field along the rotation axis, and also has radial auxiliary coils may realize a hybrid including a magnetic coupling for contactless transmission of a torque and including an active magnetic bearing. Both bearing of one of the two coupling parts in the axial direction and a transmission of a torque between the two coupling parts may be provided by suitable control of the coils that generate the magnetic field along the rotation axis. Bearing of one of the two coupling parts in the radial directions may be provided by suitable control of the radial auxiliary coils. A magnetic coupling may both contactlessly transmit a torque and also assume responsibility for radially and axially bearing at least one of the two coupling parts. An additional bearing or additional bearings may be dispensed with as a result.

In an embodiment, the magnetic coupling has a yoke that is configured to guide a magnetic field that is generated by the at least one coil.

The yoke may be produced from a material that has a magnetic permeability of >1, or >80. Stray fields may be further reduced as a result.

The yoke may bundle the field lines of the magnetic field in the yoke's interior and as a result intensify a magnetic flux Φ. Since a magnetic force Fm is proportional to Φ2/S, where S is the effective cross-sectional area the magnetic field, the resulting force may also be changed by changing the magnetic flux Φ.

In an embodiment, the yoke is U-shaped at least in sections.

For example, the limbs of the yoke that is U-shaped at least in sections may run perpendicular in relation to the rotation axis. Since a magnetic force that acts between at least one of the two coupling parts and the yoke is greater the smaller the distance between the yoke and the coupling part, a greater distance may be provided between the yoke and the first coupling part and/or the second coupling part in the radial direction than in the axial direction. The influence of radial stray fields may be further reduced as a result.

In an embodiment, the yoke further has at least one projection that is configured to guide a magnetic field that is generated by one of the at least three radial auxiliary coils, radially with respect to the rotation axis.

The projection may be produced from a material that has a magnetic permeability of greater than one. The projection may be produced from the same material as the yoke. The projection and the yoke may be of integral design. The at least one projection may be configured in such a way that at least one of the at least three auxiliary coils is formed around the projection. By way of example, the projection may be configured as a coil core.

The yoke may include a projection for each of the at least three radial auxiliary coils. Each of the projections is configured to guide a magnetic field that is generated by in each case one of the at least three radial auxiliary coils, radially with respect to the rotation axis.

In an embodiment, the magnetic coupling further has a control device that is configured to control an electric current flow through the at least one coil.

A magnetic field that is generated by a coil is proportional to an electric current flow that flows through the coil. For example, the magnetic flux Φ that is generated by a coil is then also proportional to the electric current that flows through the coil. A magnetic force Fm is proportional to Φ2/S, where S is the effective cross-sectional area the magnetic field. The magnetic flux and also the generated magnetic field may be controlled by controlling the electric current flow through the at least one coil. The force that results from the generated magnetic field may also be controlled by controlling the electric current flow through the at least one coil. Contactless transmission of a torque between the first coupling part and the second coupling part may therefore be controlled by controlling the electric current flow through the at least one coil.

In an embodiment, the control device is configured to reverse a direction of the electric current flow through the at least one coil.

As such, a position of the first and/or second coupling part may be adjusted in opposite directions.

When the magnetic coupling is in a saturation state, e.g. when an increase in an applied external magnetic field does not cause a further increase in magnetization of a material that is located in the magnetic field, a current flow may be reversed through the at least one coil in order to counter the saturation.

In an embodiment, the control device is configured to control the electric current flow through the at least one coil in such a way that a distance between the first coupling part and the second coupling part along the rotation axis may be adjusted.

The control device may be configured to control the distance between the first coupling part and the second coupling part along the rotation axis. For example, a sensor may be provided, that ascertains a value for the distance between the first coupling part and the second coupling part along the rotation axis. The sensor supplies the result to the control device. The control device may be configured to control a distance between the first coupling part and the second coupling part along the rotation axis based on the ascertained value.

In an embodiment, the control device is configured to control the current flow through the at least one coil in such a way that the second coupling part levitates in the magnetic field that is generated by the at least one coil.

For example, sensors ascertain a position of the second coupling part in three dimensions, for example an axial position and two radial positions with respect to the rotation axis, and supply the results to the control device. The control device may be configured to control a current flow through the at least one coil based on the ascertained values. For example, the control device may, in order to levitate the second coupling part, control a current flow through two coils, which each generate a magnetic field along the rotation axis, and a current flow through three coils, which each generate a radial magnetic field. As a result, a hybrid including a magnetic coupling and an active magnetic bearing may be realized. Additional bearings, which support the second coupling part, may be dispensed with. Control of a magnetic hybrid coupling of this kind may control both torque transmission and also a position of the coupling part. The number of components may be reduced as a result. Damping and/or avoiding natural frequencies may be achieved.

In an embodiment, the first coupling part has at least one first axial projection and the second coupling part has at least one second axial projection. The at least one first axial projection and the at least one second axial projection are each formed from a magnetizable material and are configured so that a magnetic reluctance between the at least one first axial projection and the at least one second axial projection is minimal when the at least one first axial projection and the at least one second axial projection are oriented axially in relation to one another.

The first axial projection and/or the second axial projection may be configured, for example, as a sector of a circle or as a segment of a circle. The term “sector of a circle” refers to a partial area of a circular area that is delimited by an arc of a circle and two circle radii. The term “segment of a circle” is a partial area of a circular area which is delimited by an arc of a circle and a circle chord.

The first coupling part and the second coupling part may each have a plurality of axial projections that together form a profile with a periodic structure. For example, the profile may have a ring including sectors of a circle that are spaced apart from one another. As an alternative or in addition to the ring, the profile may also have a further ring that has segments of a circle that are spaced apart from one another. The at least one first projection may be arranged in a mirror-inverted manner in relation to the at least one second projection.

If the axial magnetic field that is generated by the at least one coil now permeates the two coupling parts of the magnetic coupling, magnetization may be built up in the at least one first projection and in the at least one second projection. The magnetizations of the respective projections may then interact with one another in such a way that a magnetic reluctance between the respective projections is minimized. The magnetic reluctance is minimized due to how a state of minimum magnetic reluctance corresponds to a state with a minimum stored magnetic energy. This state of minimum stored magnetic energy may be provided in the described magnetic coupling when the at least one first projection and the at least one second projection are situated exactly axially opposite one another. In this position, a magnetic flux may flow directly from the at least one first projection to the at least one second projection where a gap that is to be bridged in the process is minimal. If the at least one first projection and the at least one second projection are not situated exactly opposite one another, a larger gap has to be overcome. A torque that is directed such that the at least one first projection and the at least one second projection are moved toward one another builds up.

In an embodiment, the first and/or the second coupling part includes at least two projections. One of the at least two projections is arranged on a first side of the first coupling part. The rotation axis is perpendicular on the first side. The other of the at least two projections is arranged on a second side of the second coupling part, the second side situated opposite the first side in the axial direction.

A torque may be transmitted on both sides of a coupling part. For example, a plurality of coupling parts may be arranged axially one behind the other. A torque may be transmitted efficiently.

In an embodiment, the first and/or second coupling parts/part are rotatably mounted.

The first coupling part may be mounted so that the first coupling part cannot move axially (axial fixed bearing).

A coupling arrangement may include a drive, a flywheel and a magnetic coupling. The flywheel is coupled to the drive with the magnetic coupling. The first coupling part may be connected to the drive or may be configured as a drive. The second coupling part may be connected to the flywheel or may be configured as a flywheel.

The drive may be, for example, an electric motor that may also be operated as a generator.

In an embodiment, the flywheel is arranged in a closed container and/or in a vacuum.

The container may be formed from a non-magnetisable material. The container may be configured as a vacuum container. Friction losses and/or losses due to a flow resistance may be further reduced as a result.

A method for controlling a magnetic coupling, as described above, is provided. An electric current flow is controlled so that a torque between the first and second coupling parts is contactlessly transmitted by a magnetic field that is generated by the at least one coil along the rotation axis.

A computer program product is provided for the method above on a program-controlled device.

For example, a computer program product may be provided or delivered, for example, as a storage medium, such as a memory card, USB stick, CD-ROM or DVD for example, or else in the form of a downloadable file by a server in a network. A download may be performed, for example, in a wireless communication network by the transmission of an appropriate file with the computer program product.

The embodiments and features described for the proposed apparatus apply to the proposed method in a corresponding manner.

### BRIEF DESCRIPTION OF THE DRAWINGS

In the interest of clarity, same elements or elements having the same effect will be provided with the same reference symbols.

FIG. 1 depicts a schematic partially sectional view along the rotation axis of a magnetic coupling according to an embodiment.

FIG. 2 depicts a perspective view of an end face of a first coupling part of the magnetic coupling of FIG. 1 according to an embodiment.

FIG. 3 depicts a schematic sectional view along the rotation axis of a magnetic coupling according to an embodiment.

FIG. 4 depicts a schematic partially sectional view along the rotation axis of a magnetic coupling according to an embodiment.

FIG. 5 depicts a schematic partially sectional view along the rotation axis of a coupling arrangement according to an embodiment.

FIG. 6 depicts a perspective view of arrangements of radial auxiliary coils according to an embodiment.

FIG. 7 depicts a perspective view of arrangement of radial auxiliary coils according to an embodiment.

FIG. 8 depicts a flowchart for controlling a magnetic coupling according to an embodiment.

### DETAILED DESCRIPTION

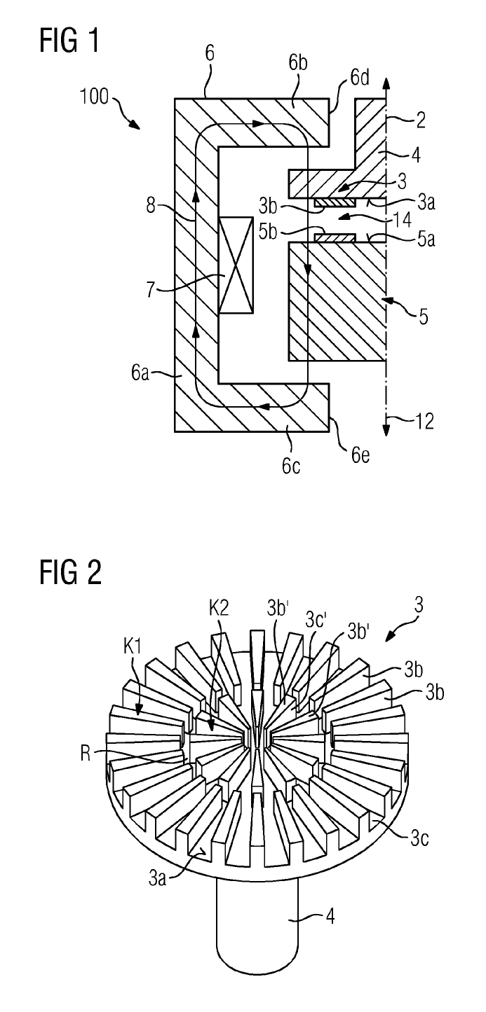

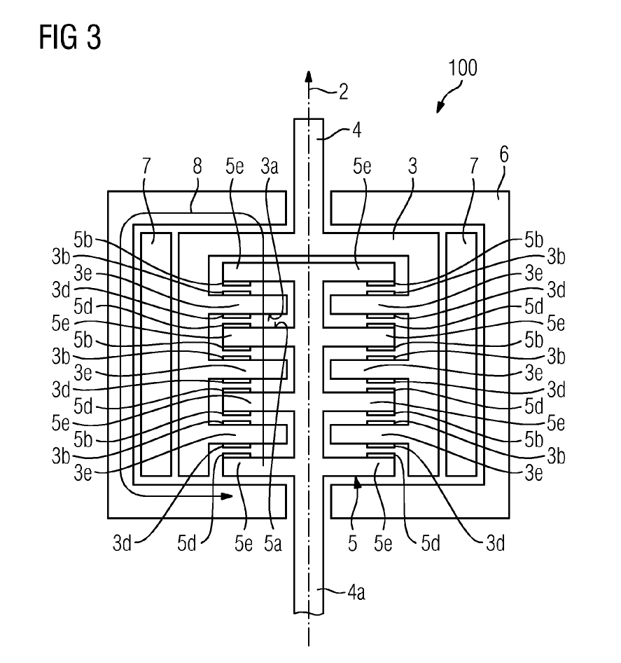

FIG. 1 depicts a schematic partially sectional view of a magnetic coupling 100. The magnetic coupling 100 may be a constituent part of a coupling arrangement 1 as depicted in FIG. 3.

The magnetic coupling 100 includes a first coupling part 3 that may rotate about the rotation axis 2 and that is connected to an electric motor (not shown) by a shaft 4. The first coupling part 3 may be rotatably mounted in a bearing, not shown, that also provides for axial fixing of the first coupling part 3.

The magnetic coupling 100 also includes a second coupling part 5 that may rotate about the rotation axis 2. The second coupling part 5 may be configured as a flywheel or the second coupling part may drive a further component (e.g., a flywheel). In the first-mentioned case, the magnetic coupling 100 forms an energy store.

The first and second coupling parts 3, 5 may each be of circular-cylindrical design and be composed of a magnetizable material (e.g., iron). The first coupling part 3 may have a larger diameter than the shaft 2 and may be integrally connected to the shaft.

The first and second coupling parts 3, 5 may have axial projections 3b, 5b on mutually facing end faces 3a, 5a, respectively. The function of the axial projections is explained in greater detail below. A gap 14 is provided between the end faces 3a, 5a or projections 3b, 5b. FIG. 2 depicts a view of the end face 3a.

The first coupling part 3 and the second coupling part 5 are surrounded, at least in sections, by a yoke 6 that is composed of a magnetizable material (e.g., pure iron). The yoke 6 is U-shaped in the half-longitudinal section shown and includes an axial section 6a and first and second radial sections 6b, 6c that adjoin the ends of the axial section. The sections 6a, 6b, 6c may be configured to be rotationally symmetrical with respect to the rotation axis 2. The sections 6b, 6c may extend radially beyond the first and, respectively, second coupling parts 3, 5.

The coupling 100 also includes a coil 7 (also referred to as “at least one coil”). The coil 7 may extend in an annular manner about the rotation axis 2. The coil 7 may be arranged along the rotation axis 2 centrally between the axial sections 6b, 6c.

The coil 7 is configured to generate a magnetic field that runs along the rotation axis 2 through the first and second coupling parts 3, 5. The yoke 6 is configured to guide the magnetic field that is generated by the coil 7. A basic profile of the magnetic flux of the magnetic field that is generated by the coil 7 is illustrated by line 8. A torque may be contactlessly transmitted between the first and second coupling parts 3, 5 by the magnetic field that runs along the rotation axis 2. If, on account of a torque that is applied, for example, to the shaft 4 or to the first coupling part 3, the projection 3b is deflected in relation to the projection 5b, a torque is produced on the second coupling part 5 owing to the applied axial magnetic field. The torque tends to arrange the projection 5b axially directly opposite the projection 3b again.

FIG. 2 depicts in perspective the end face 3a of the first coupling part 3. A plurality of projections 3b, 3b′ are arranged in a circular manner on the end face 3a. Each of the projections 3b, 3b′ is configured as a segment of a ring. The respective projections 3b are arranged at a distance from one another (e.g., there is an air gap 3c, 3c′ between the two individual projections 3b, 3b′). The projections 3b may be arranged in an outer ring K1, and the projections 3b′ may be arranged in an inner ring K2. The number of projections 3b in the outer ring K1 may be greater than the number of projections 3b′ in the inner ring K2. The projections 3b may be spaced apart from the projections 3b′ by a radial gap R. The second coupling part 5 has, on the end face 5a, correspondingly arranged projections, only partially shown.

As the deflection of one of the two coupling parts 3, 5 becomes greater, a torque increases. The maximum possible torque is reached when the deflection between the coupling parts 3 and 5 is such that, for example, the projection 5b of the coupling part 5 is located exactly above the air gap 3c between two projections 3b of the coupling part 3 that are situated next to one another. A further deflection in the same direction would provide that the mathematical sign of the torque is reversed.

FIG. 3 depicts a schematic sectional view of a magnetic coupling 100. The magnetic coupling 100 depicted in FIG. 3 has a first coupling part 3, that is connected to a shaft 4, and a second coupling part 5 that is connected to a further shaft 4a. The two coupling parts are by a yoke 6 that is configured to guide a magnetic field that is generated by a coil 7. The first coupling part 3 includes four sections 3e that are arranged at a distance from one another. The second coupling part 5 likewise includes four sections 5e that are arranged between the sections 3e of the first coupling part or engage between the sections. The sections 3e, 5e each have corresponding projections 3b, 3d, 5b, 5d on opposite sides.

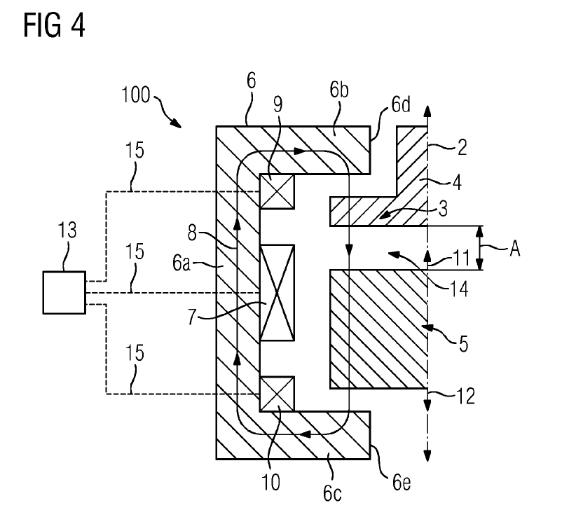

FIG. 4 shows a magnetic coupling 100 that, in contrast to FIG. 1, has a first auxiliary coil 9 and a second auxiliary coil 10. The auxiliary coils 9, 10 may each extend in an annular manner about the rotation axis 2.

The first auxiliary coil 9 is arranged, for example, adjacent to the first, radial section 6a. As a result, the first auxiliary coil 9 may change, for example, a magnetic flux in this region or in the region of the free end 6d of the first, radial section 6a. An increase in the magnetic flux 8 in the region between the yoke 6 and the first coupling part 3 may lead to a magnetic force that results from the magnetic flux 8 and that moves the two coupling parts 3, 5 toward one another, illustrated by an increase in the arrow 11 in FIG. 4.

The second auxiliary coil 10 opposite the first auxiliary coil 9 is arranged, for example, adjacent to the section 6c. As a result, the second auxiliary coil 9 may change, for example, a magnetic flux in this region or in the region of the free end 6e of the second, radial section 6c. An increase in the magnetic flux 8 in the region between the yoke 6 and the second coupling part 5 may lead to a magnetic force that results from the magnetic flux 8 and moves the two coupling parts 3, 5 away from one another, illustrated by an increase in the arrow 12 in FIG. 4.

For efficient torque transmission between the first and second coupling parts 3, 5, a distance A or a width of the gap 14 between the two coupling parts 3, 5 may be controlled. The coil 7, the first auxiliary coil 9 and the second auxiliary coil 10 are connected to a control device 13 via control lines 15. The control device 13 is configured to control an electric current flow through the coil 7, the first auxiliary coil 9 and the second auxiliary coil 10.

The magnetic coupling 100 may have a sensor (not shown) that measures the distance A between the two coupling parts 3, 5. The control device 13 may be configured to control the electric current flow based on the measured distance A. A magnetic bearing function, for example, for the second coupling part 5 may be provided in the axial direction as a result. The control device 13 may be configured to control a position of the second coupling part 5 so that the second coupling part levitates. The force of gravity in the Figures may point in the direction of the bottom edge of the sheet, but equally, other orientations of the coupling 100 with respect to the force of gravity may be used.

The control device 13 may also reverse a direction of the electric current flow through the coil 7, the first auxiliary coil 9 and/or the second auxiliary coil 10. As a result, the distance A may be controlled in a flexible manner and possibly counter saturation of the magnetic flux 8.

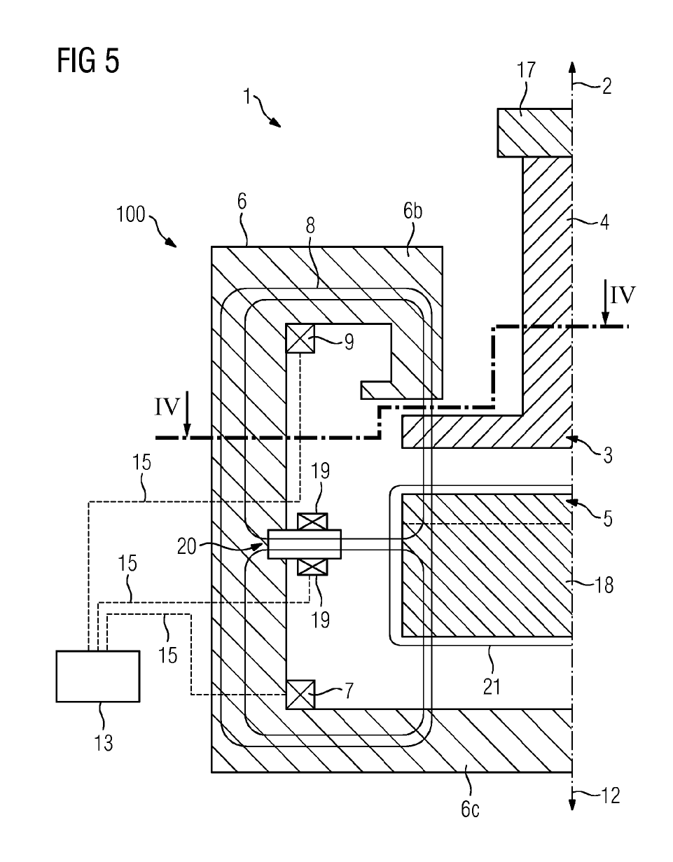

FIG. 5 shows a schematic partially sectional view of a coupling arrangement 1 according to an embodiment.

The coupling arrangement 1 has a drive 17, a magnetic coupling 100 and a flywheel 18. The flywheel 18 is configured as a separate part and is driven by the second coupling part 5. The flywheel 18 and the second coupling part 5 may be integrally formed.

In a first operating mode, the drive 17 (e.g., an electric motor) stores energy in the flywheel 18. In a second operating mode, the energy is supplied from the flywheel 18 to the drive 17. A corresponding electric motor 17 may be operated as a generator in the second operating mode. The changeover between the first and second operating modes may be performed by the control device 13.

In order to minimize frictional losses, the second coupling part 5, including the flywheel 18, may be arranged in a vacuum. The second coupling part 5, including the flywheel 18, may be accommodated in an evacuated container 21. The container wall may be formed from plastic or another material that is permeable to the magnetic field 8.

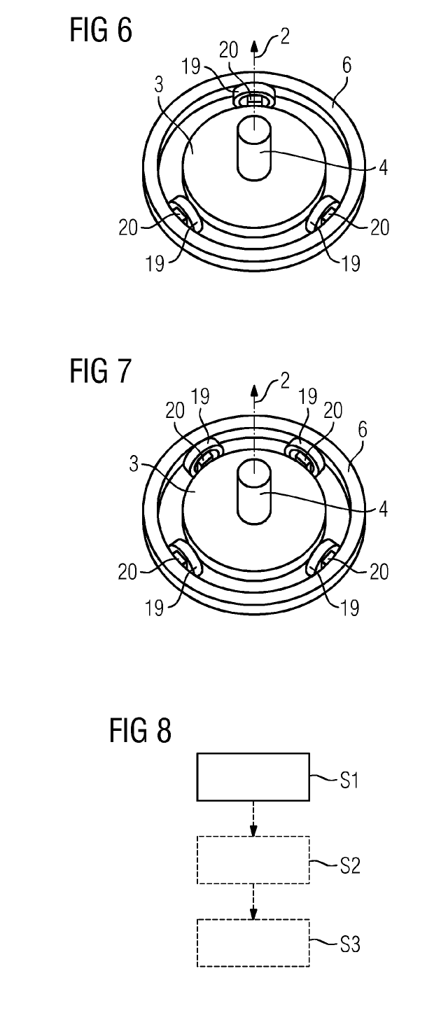

The magnetic coupling 100 according to FIG. 5 has a plurality of radial auxiliary coils 19. Only one radial auxiliary coil 19 is depicted in FIG. 3. The radial auxiliary coils 19 are arranged distributed circumferentially around the flywheel 18 with respect to the rotation axis 2. Exemplary arrangements for the radial auxiliary coils 19 are depicted in FIGS. 6 and 7.

The radial auxiliary coils 19 generate a magnetic field radially in relation to the rotation axis 2 when electric current flows through the radial auxiliary coils. The radial auxiliary coils 19 allow forces that act on the first coupling part 3 and/or the second coupling part 5 or the flywheel 18 radially in relation to the rotation axis 2 to be compensated. The radial auxiliary coils 19 are arranged around in each case one projection 20 of the yoke 6. The one projection 20 may be produced from the same material as the yoke 6.

In the coupling arrangement 100 according to FIG. 1, the coil 7 (also referred to as “at least one coil”) is arranged adjacent to the second, radial section 6c. Also, for example, only one auxiliary coil 8 that is arranged adjacent to the first, radial section 6b is provided.

The magnetic coupling 100 of the coupling arrangement 1 further includes a control device 13 that controls an electric current flow via the control lines 14, 15, 16 in the coil 7, in the first auxiliary coil 9 and in each of the radial auxiliary coils 19. The control device 13 may be configured to control a position of the flywheel 18 such that the flywheel 18 levitates.

The flywheel 18 may be mounted both in the axial direction and also the radial directions. A hybrid including a magnetic coupling for contactless transmission of a torque and including an active magnetic bearing may thus be provided.

FIGS. 6 and 7 depict schematic views of arrangements of the radial auxiliary coils 19 according to section IV from FIG. 5.

FIG. 6 depicts an arrangement of three radial auxiliary coils 19 that are arranged uniformly distributed circumferentially around the first coupling part 3 with respect to the rotation axis 2. Each of the three radial auxiliary coils 19 is arranged around a radial projection 20 of the yoke 6. The radial projection 20 is directed toward the rotation axis 2.

FIG. 7 depicts an arrangement of four radial auxiliary coils 19 that are arranged uniformly distributed circumferentially around the first coupling part 3 with respect to the rotation axis 2. Each of the four radial auxiliary coils 19 is arranged around a projection 20 of the yoke 6.

FIG. 8 depicts a flowchart of a method for controlling a magnetic coupling. An electric current flow is controlled in act S1 so that a torque between the first and second coupling parts 3, 5 of the magnetic coupling 100 is contactlessly transmitted by a magnetic field that is generated by a coil 7 along the rotation axis 2. The method may further include a second act S2 in which an electric current flow through at least one auxiliary coil 9, 10 is additionally controlled. The method may also include a third act S3 in which an electric current flow through at least three radial auxiliary coils 19 is additionally controlled.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A magnetic coupling comprising:
a first coupling part configured to be rotated about a rotation axis;
a second coupling part configured to be rotated about the rotation axis; and
at least one coil configured to generate a first magnetic field along the rotation axis through the first coupling part and second coupling part for contactless transmission of a torque between the first coupling part and the second coupling part.

2. The magnetic coupling of claim 1, further comprising:
a first auxiliary coil configured to generate a second magnetic field along the rotation axis,
wherein the first auxiliary coil is arranged along the rotation axis at a first distance from the at least one coil.

3. The magnetic coupling of claim 2, further comprising:
a second auxiliary coil configured to generate a third magnetic field along the rotation axis,
wherein the second auxiliary coil is arranged on a side of the at least one coil that is situated opposite the first auxiliary coil and along the rotation axis at a second distance from the at least one coil.

4. The magnetic coupling of claim 1, further comprising:
at least three radial auxiliary coils configured to generate a second magnetic field radially in relation to the rotation axis,
wherein the at least three radial auxiliary coils are arranged distributed circumferentially with respect to the rotation axis around the first coupling part, the second coupling part, or the first coupling part and the second coupling part.

5. The magnetic coupling of claim 1, further comprising:
a yoke configured to guide the first magnetic field generated by the at least one coil.

6. The magnetic coupling of claim 5, wherein the yoke is U-shaped at least in sections.

7. The magnetic coupling of claim 5, wherein the yoke comprises at least one projection configured to guide a second magnetic field, which is generated by one of at least three radial auxiliary coils, radially with respect to the rotation axis.

8. The magnetic coupling of claim 1, further comprising:
a control device configured to control an electric current flow through the at least one coil.

9. The magnetic coupling of claim 8, wherein the control device is further configured to reverse a direction of the electric current flow through the at least one coil.

10. The magnetic coupling of claim 8, wherein the control device is further configured to control the electric current flow through the at least one coil so that a distance between the first coupling part and the second coupling part along the rotation axis is adjustable, the second coupling part levitates in the first magnetic field, which is generated by the at least one coil, or the distance between the first coupling part and the second coupling part along the rotation axis is adjustable and the second coupling part levitates in the first magnetic field generated by the at least one coil.

11. The magnetic coupling of claim 1, wherein the first coupling part comprises at least one first axial projection and the second coupling part comprises at least one second axial projection,
wherein the at least one first axial projection and the at least one second axial projection are each formed from a magnetizable material and are configured so that a magnetic reluctance between the at least one first axial projection and the at least one second axial projection is minimal when the at least one first axial projection and the at least one second axial projection are oriented axially in relation to one another.

12. The magnetic coupling of claim 1, wherein the first coupling part is rotatably mounted, the second coupling part is rotatably mounted, or the first coupling part and the second coupling part are rotatably mounted.

13. A coupling arrangement comprising:
a drive;
a flywheel; and
a magnetic coupling comprising:
a first coupling part configured to be rotated about a rotation axis;
a second coupling part configured to be rotated about the rotation axis; and
at least one coil configured to generate a first magnetic field along the rotation axis through the first coupling part and the second coupling part for contactless transmission of a torque between the first coupling part and the second coupling part.

14. The coupling arrangement of claim 13, wherein the flywheel is arranged in a closed container, a vacuum, or the closed container and the vacuum.

15. A method for controlling a magnetic coupling, the method comprising:
generating a magnetic field by at least one coil along a rotation axis of a first coupling part and a second coupling part, and through the first coupling part and the second coupling part; and
controlling an electric current flow through the at least one coil so that a torque between the first coupling part and the second coupling part is contactlessly transmitted by the magnetic field.

16. The coupling arrangement of claim 13, wherein the magnetic coupling further comprises:
a first auxiliary coil configured to generate a second magnetic field along the rotation axis,
wherein the first auxiliary coil is arranged along the rotation axis at a first distance from the at least one coil.

17. The coupling arrangement of claim 16, wherein the magnetic coupling further comprises:
a second auxiliary coil configured to generate a third magnetic field along the rotation axis, wherein the second auxiliary coil is arranged on a side of the at least one coil that is situated opposite the first auxiliary coil and along the rotation axis at a second distance from the at least one coil.

18. The coupling arrangement of claim 13, wherein the magnetic coupling further comprises:
a control device configured to control an electric current flow through the at least one coil, the control device further configured to reverse a direction of the electric current flow through the at least one coil.

19. The magnetic coupling of claim 4, further comprising:
a yoke configured to guide the first magnetic field generated by the at least one coil.

20. The magnetic coupling of claim 18, wherein the yoke comprises:
at least one projection configured to guide the second magnetic field generated by the one of the at least three radial auxiliary coils, radially with respect to the rotation axis.
